(19) United States
(12) Patent Application Publication
(10) Pub. No.: US 2024/0258577 A1
(43) Pub. Date: Aug. 1, 2024

(54) A Method of Printing a Component in an Electrochemical Cell

(71) Applicant: QinetiQ Limited, Hampshire (GB)

(72) Inventors: Max William Angus Reid, Farnborough, Hampshire (GB); Robert Nathan Williams, Farnborough, Hampshire (GB)

(21) Appl. No.: 18/565,966

(22) PCT Filed: May 31, 2022
(86) PCT No.: PCT/EP2022/064758

§ 371 Date: Nov. 30, 2023

(30) Foreign Application Priority Data
Jun. 4, 2021 (GB) 2108056.9

(51) Int. Cl. H01M 10/0585; B41M 1/26; B41M 3/00; H01M 10/0565

(52) U.S. Cl. CPC H01M 10/0585; B41M 1/26; B41M 3/001; B41M 3/008; H01M 10/0565; H01M 2300/0082

(57) ABSTRACT

A method of printing an electrolyte for an electrochemical cell, the method comprising: providing an ink, the ink comprising a solvent and an electrolyte-forming material, the electrolyte-forming material comprising an electrolyte species and a polymer: printing the ink onto a medium to form an ink layer on the medium; allowing the ink to dry or cure to cause the electrolyte forming material to form an electrolyte layer on the medium. Also provided are electrodes made using the method, electrolytic cells comprising the electrodes and articles comprising the electrolytic cells.

The invention relates to a method of printing a component for an electrochemical cell. The component may be an active layer such as an electrode and/or an electrolyte. The invention also relates to inks for use in such methods.

### BACKGROUND

With electronic devices being used in many aspects of modern life, ways of storing energy to power them are increasingly important. Electrochemical cells, more specifically batteries, have been used for over 100 years to directly convert chemical energy to electrical energy utilizing a wide variety of chemistries and cell formats.

Many of these cell formats exhibit a rigid construction. These include cylindrical cells such as the widely used AA cell, and button cells often used when small, low power cells are required.

With developments in the thin, flexible electronics market, there is a growing demand for correspondingly thin, flexible, low cost cells. Some applications of these cells may be for wearable electronic devices, smart labels, and smart cards. Many of the popular rigid constructions are not suitable for these applications due to their increased bulkiness and mass, and thus new low profile, flexible cells and methods of manufacture are of immense value.

It is also important to be able to produce such cells at high volume and at a low cost, while achieving high performance.

An area of interest for obtaining improvements in production volume is different printing methods, which allow for cell production with high throughput rates with consistency. Some of the printing methods that have been investigated include screen printing, lithographic or offset printing, and flexographic printing. The rapid printing of cells with these techniques could decrease unit cost compared to slower printing methods.

Such high-speed methods are attractive for high through-put printing, but are problematic because they require inks of low viscosity, and can only print layers of limited thickness—typically less than 20 microns thick. Achieving low viscosity while maintaining sufficiently high loading of active materials is particularly difficult.

A fully printed cell can also present challenges due to construction of layers in contact with each other, requiring inks compatible with the chosen process and with the other cell components. There are also challenges in printing/laying of the electrochemical cell components and ensuring an airtight seal to contain the cell components, as well as preventing ingress of external species.

It is against this background that the invention has been devised.

### STATEMENTS OF THE INVENTION

From a first aspect the invention resides in an ink for printing an active layer in an electrochemical cell using a high-speed printing process. The ink comprises a solvent and an active-layer-forming material for forming an active layer. The active-layer-forming material comprises an active material in suspension in the solvent; and a polymeric binder.

The composition of the ink is advantageous as it can be used to print active layers such as electrodes that are compatible with high volume manufacturing methods, including but not limited to, flexographic printing, rotary screen printing, reel to reel printing. The ink can be used to print electrodes for all varieties of electrochemical cell, but especially thin and flexible electrodes for use in thin and flexible film electrochemical cells, for example those between about 1 and 1000 microns in thickness. By making use of a printing process, this method can print electrodes for electrochemical cells both easily and quickly. The printed active layers formed by the ink are robust and remain in contact with the medium and the electrolyte. Further, the printed active layers can be used as the subsequent medium to further build up electrode thickness to increase performance of the electrochemical cell.

The active material may be a particulate material comprising a plurality of discrete particles.

The discrete particles may be provided as flakes, fibres, or general particulate.

The particles may be of a size less than 20 microns, preferably less than 10 microns, and most preferably of a size between 1 nm and 10 microns.

The active layer may be an electrode and the active material may be an electrode material.

The electrode material may comprise an inorganic lattice material, optionally selected from the group of: manganese dioxide, zinc, lithium colbalt oxide (LCO), lithium iron phosphate (LFP), graphite, nickel hydroxide, cadmium or silver oxide.

The binder may be is dissolved in the solvent.

The binder may comprise one or more polymers selected from the group of: polyvinyl alcohol, polyacrylamide, polyacrylic acid, polyethylene glycol, polyamines, polyvinylpyrrolidone and methyl cellulose. The binder may comprise a mixture of more than one polymer.

The solvent may be a polar or non polar solvent and may for example comprise water or alcohol.

The active-layer-forming material may further comprise a conductive material.

The conductive material may comprise a conductive carbon additive, optionally comprising carbon black (for example in the form of acetylene black particulates), and/or graphite (for example in the form of graphite flakes), and/or carbon nanotubes (for example in the form of single wall carbon nanotubes or multi wall carbon nanotubes).

The active-layer-forming material may comprise up to approximately 40 wt % conductive material, preferably between approximately 5 wt % and approximately 20 wt % conductive material.

The ink may comprise between approximately 30 wt % and approximately 95 wt % solvent, preferably between approximately 50 wt % and approximately 90 wt % solvent.

The ink may comprise between approximately 5 wt % and approximately 70 wt % active-layer-forming material, preferably between approximately 10 wt % and approximately 50 wt % active-layer-forming material.

The active-layer-forming material may comprise between approximately 40 wt % and approximately 98 wt % active material, preferably between approximately 65 wt % and approximately 90 wt % active material.

The active-layer-forming material may comprise may comprise up to approximately 40 wt % binder, preferably between approximately 5 wt % and approximately 20 wt % binder.

The active-layer-forming material may further comprise an inert filler.

The active-layer-forming material may comprise up to approximately 50 wt % inert filler, preferably up to approximately 10 wt % inert filler.

The active-layer-forming material may further comprise a dispersion agent.

The active-layer-forming material may comprise up to approximately 5 wt % dispersion agent, preferably between approximately 0.1 wt % and approximately 1 wt % dispersion agent.

The active-layer-forming material may further comprise an additive, for example an anti-drying agent, dispersion agent, defoaming agent and/or emulsifier.

The ink may have a viscosity in the range of approximately 50 to approximately 500 centipoise (cps) when measured at a shear rate of 1000 to 100,000 s⁻¹.

The solvent may be water or alcohol.

The invention also extends to a method of printing an active layer for an electrochemical cell, the method comprising: providing the ink described above; printing the ink on a medium to form an ink layer; and allowing the ink to dry or cure to form an active layer.

The step of printing the ink may use a high-speed printing process having a print rate of at least 10 metres per minute, preferably at least 50 metres per minute.

The step of printing the ink may use flexographic printing, rotary screen printing, rotogravure printing or reel-to-reel printing.

The ink layer may be printed with a thickness that is 100 microns or less, preferably 20 microns or less.

The method may comprise printing a further ink layer over the ink layer and allowing the further ink layer to dry or cure. Using a further ink layer increases a thickness of the active layer.

The active layer may be an electrode and the active material may be an electrode material.

The invention extends further to a method of making an electrochemical cell, the method comprising: a) providing a first electrode ink, the first electrode ink comprising a solvent; and a first electrode-forming material for forming a first electrode, wherein the first electrode-forming material comprises: a first active material in suspension in the solvent; and a polymeric binder; b) printing the first electrode ink on a medium to form a first electrode ink layer; c) allowing the first electrode ink to dry or cure to form the first electrode layer; d) arranging an electrolyte over the first electrode; and e) arranging a second electrode over the electrolyte.

The step of arranging an electrolyte over the first electrode may comprise: providing an electrolyte ink, the ink comprising a solvent and an electrolyte-forming material, the electrolyte-forming material comprising an electrolyte species and a polymer; printing the ink onto the first electrode to form an electrolyte ink layer on the first electrode; and allowing the electrolyte ink to dry or cure to cause the electrolyte forming material to form an electrolyte layer on the first electrode.

The step of arranging the second electrode over the electrolyte may comprise: providing a second electrode ink, the second electrode ink comprising a solvent; and a second electrode-forming material for forming a second electrode; wherein the second electrode-forming material comprises: a second active material in suspension in the solvent and a polymeric binder; printing the second electrode ink on the electrolyte to form a second electrode ink layer; and allowing the second electrode ink to dry or cure to form the second electrode layer.

The first electrode may be a negative electrode and the second electrode may be a positive electrode.

The medium may be a current collector layer.

From another aspect the invention resides in a method of printing an electrolyte for an electrochemical cell. The method comprises: providing an ink, the ink comprising a solvent and an electrolyte-forming material, the electrolyte-forming material comprising an electrolyte species and a polymer; printing the ink onto a medium to form an ink layer on the medium; and allowing the ink to dry or cure to cause the electrolyte forming material to form an electrolyte layer on the medium.

The method of this aspect is advantageous as it can be used to print electrolytes for all varieties of electrochemical cell, but especially thin and flexible electrolytes for use in thin and flexible film electrochemical cells, for example those between about 1 and 500 microns in thickness. By making use of a printing process, this method can print electrolytes for electrochemical cells both easily and quickly. The printed electrolytes formed by the method are robust layers and remain in contact with both electrodes.

The step of printing the ink may use a high-speed printing process having a print rate of at least 10 metres per minute, preferably at least 50 metres per minute.

The step of printing the ink may use flexographic printing, rotary screen printing, rotogravure printing or reel-to-reel printing.

The ink layer may be printed to have a thickness that is 100 microns or less, preferably 20 microns or less.

The ink may have a viscosity in the range of approximately 50 to approximately 500 centipoise when measured at a shear rate of 1000 to 100,000 s⁻¹.

The polymer may be capable of forming a connected polymer network on drying or curing.

The polymer may be a carbon-backboned polymer with polar side groups.

The polymer may be a cross-linkable polymer, and the method may comprise allowing the ink to cure by allowing the polymer to form cross-links.

The polymer may comprise polyvinyl alcohol, polyacrylamide, polyacrylic acid, polycarbonate, polysulfone or polyurethane.

The electrolyte-forming material may further comprise a cross-linking catalyst configured to catalyse the formation of cross-links in the polymer.

The cross-linking catalyst may comprise an oxidising species, optionally potassium persulfate.

The ink may comprise approximately 0.001 wt % to approximately 1 wt % cross-linking catalyst.

The ink may comprise approximately 1 wt % to approximately 50 wt % polymer.

The ink may comprise approximately 1 wt % to approximately 50 wt % electrolyte species.

The electrolyte-forming material may further comprise a surfactant.

The surfactant may comprise a long chain anionic molecule, a long chain cationic molecule, a non-ionic molecule and/or an amphoteric molecule.

The electrolyte-forming material may further comprise an additive.

The ink may comprise approximately 0.01 wt % to approximately 10 wt % additive.

The additive may comprise an anti-drying agent, a wetting agents, a defoaming agent, inert filler and/or an emulsifier.

The solvent may be a polar on non-polar solvent such as water or alcohol.

The ink may comprise 25% to 99.9% solvent.

The electrolyte species may be a hydroxide, chloride or sulphate species, for example a potassium hydroxide, zinc chloride or zinc sulphate.

A single ink can be used to form the electrolyte. The use of a single ink is advantageous as the electrolyte layer can be applied in a single printing mechanism to facilitate very high speed printing techniques such as flexography.

Alternatively, multiple inks can be used to form the electrolyte. For example, an ink containing an electrolyte species can be printed, and another ink containing an electrolyte species can subsequently be printed, such that the two inks have contact. The interaction of the inks can generate a more robust layer than one single ink can through furthered cross-linking in their interaction. For example, one ink can contain polyvinyl alcohol as the gel polymer, another ink can contain acrylamide as the polymer, and the two inks can be printing one after the other on the same space so that the polymers interact at the inks' interfaces to facilitate cross-linking and form a robust electrolyte layer. The use of multiple inks is advantageous as it limits the extent of cross-linking until the species are in contact on the medium, being able to form a better coverage of electrolyte layer in the electrochemical cell.

Where multiple inks are used the method may further comprise: printing a further ink layer over the ink layer, the further ink layer comprising a solvent and a further electrolyte-forming material, the further electrolyte-forming material comprising an electrolyte species and a second polymer different to the first polymer, and allowing the first and second ink layers to dry or cure to form the electrolyte layer on the medium.

The method may comprise allowing the first and second ink layers to dry or cure simultaneously to form the electrolyte layer on the medium.

The first and second polymers may be selected to react together, and the method may further comprise: allowing the first ink and the second ink to react at an interface between the first ink layer and the second ink layer as the first and second ink layers dry or cure to form the electrolyte layer on the medium.

The invention also extends to a method of making a part of an electrochemical cell, the method comprising: providing a medium comprising an electrode having an electrode surface; printing an electrolyte layer onto the electrode surface according to any of the above methods.

The step of providing the medium may comprise: providing a substrate; providing an electrode ink suitable for forming an electrode; printing the electrode ink on the substrate; and allowing the electrode ink to dry or cure to form the electrode.

The electrode may be a positive electrode and the electrode ink may be suitable for forming a positive electrode.

The invention also extends to a method of making an electrochemical cell, the method comprising: making a part of an electrochemical cell according to the method described above arranging a further electrode on the electrolyte layer to form an electrochemical cell.

The step of arranging a further electrode on the electrolyte layer to form an electrochemical cell may comprise: providing a further medium comprising a further electrode having a further electrode surface; arranging the electrolyte layer and the further electrolyte layer face-to-face to form an electrochemical cell.

The step of arranging a further electrode on the electrolyte layer may instead comprise: providing a further electrode ink suitable for forming the further electrode; printing the further electrode ink on the electrolyte layer; and allowing the further electrode ink to dry or cure to form the further electrode.

The method may further comprise arranging a separator between the electrode and the further electrode.

The further electrode may be a negative electrode.

The or each substrate may be a current collector layer.

The invention extends further to a method of printing an electrolyte for an electrochemical cell, the method comprising:
providing a first ink comprising a solvent and a first electrolyte-forming material, the first electrolyte-forming material comprising an electrolyte species and a first polymer;
printing the first ink onto a medium with a printing process to form a first ink layer on the medium;
providing a second ink comprising a solvent and a second electrolyte-forming material, the second electrolyte-forming material comprising an electrolyte species and a second polymer;
printing the second ink onto the first ink layer to form a second ink layer;
allowing the first and second ink layers to dry or cure to form an electrolyte layer on the medium.

The invention also extends to an electrode made using any of the inks described above and/or any of the methods described above, to an electrolytic cell comprising any of the electrodes or electrolytes described above, and to an article comprising said electrolytic cells.

Optionally providing the first electrode comprises depositing the first electrode on a substrate in a printing line; and/or providing the second electrode comprises depositing the second electrode on the electrolyte in a printing line.

Depositing both of the electrodes on a printing line is beneficial as a complete electrochemical cell may be manufactured in a single printing run allowing for a fast inexpensive method of electrochemical cell production. In some examples the entire electrochemical cell may be printed using a single printing device. Reel-to-reel depositing may be used which negates the need for other equipment which might slow down the production process and reduce consistency. This method may be used to manufacture all kinds of electrochemical cells, but especially thin film electrochemical cells.

Instead of printing, the first and/or second electrodes may be provided and applied using any suitable process.

The substrate may be an electrically insulating material or a conductive material; a fabric, a polymer, a glass, a paper, a metal, or a ceramic. The substrate may itself comprise a previously printed material, and may include electronic circuits.

Optionally the step of providing the first electrode on the substrate comprises printing a first current collector on the substrate and printing the first electrode on the first current collector.

The method may optionally comprise printing a second current collector on the second electrode.

The method may optionally comprise depositing a second electrode on the second current collector on a separate substrate, which is combined with the electrolyte on the first electrode on the first current collector to form an electrochemical cell. The method may optionally comprise depositing a second electrode directly on a separate substrate. The method ma optionally provide the second electrode comprises delaminating the second electrode onto the electrolyte.

Delaminating a second electrode is beneficial as the material can be manufactured prior to the printing of the electrolyte, negating the need to include complex manufacturing techniques into the same printing process. In one example, the second electrode may comprise of an electrode foil adhered to a substrate. This enables a robust second electrode and sealing of the electrochemical cell during delamination.

Alternatively, the current collectors can be provided and applied to the electrochemical cell at any suitable point in the manufacturing process using any suitable process. The current collectors serve to maximise current flow for the electrodes.

In a further aspect, the present invention provides a method of forming an electrochemical cell comprising:
providing a first electrode;
printing an electrolyte ink on the first electrode;
optionally, printing subsequent electrolyte inks on preceding electrolyte inks;
providing a separator material, wherein the separator material is in contact with the preceding electrolyte or electrolytes; and
providing a second electrode, wherein the electrolyte and separator material are located between the first and second electrodes in the so formed electrochemical cell.

Optionally, providing the separator material can come prior to printing the electrolytes, wherein the method of forming an electrochemical cell comprises:
providing a first electrode;
providing a separator material, wherein the separator material is in contact with the preceding electrolyte or electrolytes;
printing an electrolyte ink on the first electrode;
optionally, printing subsequent electrolyte inks on preceding electrolyte inks; and
providing a second electrode, wherein the electrolyte and separator material are located between the first and second electrodes in the so formed electrochemical cell.

Providing a separator material is beneficial as it increases the resilience of the electrochemical cell to short-circuiting, and enables the electrolyte to wet into the material to increase contact area with the electrodes.

In a further aspect, the present invention provides a method of forming an electrochemical cell comprising:
providing a first electrode on a first portion of a substrate;
providing a second electrode on a second portion of the substrate, wherein the second portion is separated from the first portion by a third portion of the substrate;
printing one or more electrolytes over one or both of the first second electrodes in accordance with the above described method wherein the medium is the first and/or second electrode; and
folding the substrate over itself such that the electrode is located between the first and second electrodes.

Optionally providing the first electrode comprises printing the first electrode on the first portion of the substrate; and/or providing the second electrode comprises printing the second electrode on the second portion of the electrode.

This method may be used to print all kinds of electrochemical cell, but especially thin film electrochemical cells.

The step of providing the first electrode on the first portion of the substrate may comprise printing a first current collector on the first portion of the substrate and printing the first electrode on the first current collector, and wherein the step of providing the second electrode on a second portion of the substrate comprises printing a second current collector on the second portion of the substrate and printing the second electrode on the second current collector.

Alternatively, the current collectors can be provided and applied to the electrochemical cell using any suitable process.

In one example, the method comprises a step of printing a protective cover on the first current collector, the first electrode, the electrode, the second electrode, or the second current collector.

The protective cover is preferably insulating and seals the electrical components of the electrochemical cell while still allowing access to the current collectors and/or the electrodes for electrical connection.

In a still further aspect, the present invention provides a method of forming an electrochemical cell comprising:
providing a first electrode;
providing a second electrode;
printing one or more electrolytes on a substrate in accordance with the method described above of wherein the medium is the substrate;
removing the electrolytes from the substrate; and
arranging the electrolyte between the first and second electrodes.

This method may be used to print all kinds of electrochemical cell, but especially thin film electrochemical cells.

Additionally, the method can include steps of providing first and second current collectors and applying the first and second current collectors to the respective first and second electrodes. This can be done using any suitable process. Alternatively, the first and/or second current collector can be printed on the respective first and second electrodes. Preferably, the method includes a final step of applying a protective cover on each outer side of the current collectors or electrodes.

Additionally, the method can include steps of providing first and second current collectors and applying the first and second current collectors to the respective first and second electrodes. This can be done using any suitable process. Alternatively, the first and/or second current collector can be printed on the respective first and second electrodes. Preferably, the method includes a final step of applying a protective cover on each outer side of the current collectors or electrodes.

Features of any one aspect or embodiment of the invention may be used, alone or in appropriate combination, with any other aspects and embodiments as may be appropriate.

In all the methods described above, the step of allowing the ink to cure or dry may comprise a step of facilitating or promoting curing or drying. Curing or drying may be facilitated or promoted by any suitable means: for example by heat, light, chemical reaction, pressure, or by means of a combination of the drying and/or curing methods.

The above aspects and optional features may be used alone or in appropriate combination.

### BRIEF DESCRIPTION OF THE DRAWINGS

The above and other aspects of the invention will now be described, by way of example only, with reference to the remainder of the accompanying drawings, in which:

FIG. 1 is a cross-sectional schematic of an electrochemical cell;

FIG. 2 is a perspective schematic of an electrode ink being applied to a medium;

FIG. 3 is a side view schematic of an electrode layer on a medium;

FIG. 4 is a flow chart indicating the steps of a method of making the electrode ink of FIG. 2;

FIG. 5 is a flow chart indicating the steps of a method of making the electrode layer of FIG. 3;

FIG. 6 is a perspective schematic of an electrolyte ink being applied to a medium;

FIG. 7 is a side view schematic of an electrolyte layer on a medium;

FIG. 8 is a flow chart indicating the steps of a method of making the electrolyte ink of FIG. 6;

FIG. 9 is a flow chart indicating the steps of a method of making the electrolyte layer of FIG. 7;

FIG. 10 is a flow chart indicating the steps of another method of making an electrolyte layer, in which two electrolyte ink layers are printed;

FIG. 11 is a cross-sectional schematic of another electrochemical cell;

FIG. 12 is a schematic view of an article of footwear incorporating an electrochemical cell that has been printed in accordance with the methods of the invention;

FIG. 13 is a schematic view of an article of packaging incorporating an electrochemical cell that has been printed in accordance with the methods of the invention;

FIG. 14 is a schematic view of a smart watch incorporating an electrochemical cell that has been printed in accordance with the methods of the invention;

FIG. 15 is a schematic view of an article of clothing incorporating an electrochemical cell that has been printed in accordance with the methods of the invention;

FIG. 16 is a photograph of an electrode printed in accordance with the described methods, showing the flexibility of the electrode;

FIG. 17 is a 100 μA continuous discharge curve for a 10 cm² electrochemical cell with an electrolyte printed in accordance with the invention;

FIG. 18 shows an electrochemical impedance spectra applying a 10 mV AC sinusoidal voltage at frequencies between 105 and 10-1 Hz, for the printed cells with different electrolytes;

FIG. 19 shows two electrodes printed via high volume manufacturing techniques, with suitable (left) and unsuitable (right) sized particles of the electrode material; and

FIG. 20 shows two electrodes printed via high volume manufacturing techniques, with suitable (left) and unsuitable (right) viscosities of the electrode ink.

### DETAILED DESCRIPTION

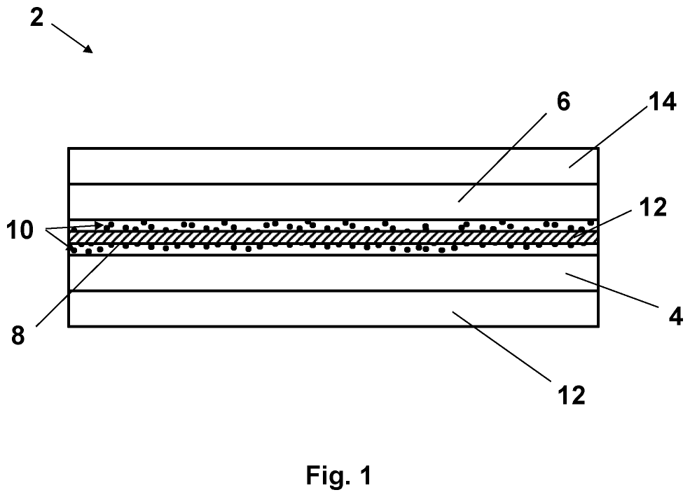

The electrochemical cell 2 of FIG. 1 is configured to provide electrical current to an electrical device (not shown). To this end, the electrochemical cell comprises a first electrode 4 in the form of a cathode, i.e. a positive electrode, and a second electrode 6 in the form of an anode, i.e. a negative electrode. To provide said electrical current, the first and second electrodes 4, 6 of the electrochemical cell are couplable to an electrical device (not shown) in a conventional way.

To bring about a flow of current between the first and second electrodes 4, 6, and hence to power an electrical device (not shown) connected to the electrochemical cell 2, the electrolyte 10 provides electrolytic ions capable of moving between the first and second electrodes 4, 6 to convey electrical current when the electrochemical cell is connected to a circuit. The electrolyte 10 is electrochemically active with respect to both the first and second electrodes 4, 6, and is selected to react with the anode 6 to produce free electrons, and react with the cathode 4 and free electrons, thereby bringing about a flow of current between the two electrodes 4, 6.

The electrolytic ions are maintained within, and yet can move through, the electrolyte 10. In this way, it may be said that the electrolyte “hosts” the electrolytic ions. This may be achieved by the electrolyte being dissolved in a polar solvent to form an electrolytic solution which resides within the electrolyte, or may be achieved by ions provided from the electrolyte (in solid or solution form) residing within the body of the electrolyte.

To prevent short circuiting between the first and second electrodes 4, 6, the electrochemical cell 2 may optionally be further provided with a separator 8 that is arranged between the first and second electrodes 4, 6. The separator 8 is chemically inert with respect to the electrolyte 10 and the first and second electrodes 4, 6. In this way, the first and second electrodes 4, 6 are electrically separated and the likelihood of short circuiting is reduced.

The electrochemical cell 2 may also comprise first and second current collectors 12, 14 configured maximise current flow between the two electrodes 4, 6. To this end, the first and second current collectors 12, 14 are arranged in contact with the respective first and second electrodes 4, 6 on the opposite side to the electrolyte. In this embodiment, the first and second current collectors 12, 14 are couplable to an electrical device (not shown).

The electrochemical cell 2 of FIG. 1 is a thin film electrochemical cell. In other words, the electrochemical cell has a thickness of between 20 and 1000 microns. To achieve such a thin film, the electrolyte 10, the electrodes 4,6 and the current collectors 12, 14 all take the form of thin film layers.

According to various aspects of the invention, one or more of the layers of the thin film electrochemical cell 2 are printed layers. For example, one or both of the electrode layers 4, 6 are printed electrode layers that have been printed using one or more electrode inks, and/or the electrolyte layer 10 is a printed electrolyte layer that has been printed using one or more electrolyte inks. It will be appreciated that these various printed layers may be used in combination with other printed layers, or other non-printed layers, to produce an electrochemical cell 2.

All of the printed layers described herein are printed onto a medium. The medium may be any suitable object having a surface onto which a layer can be printed. In some cases, the medium will be another component of an electrochemical cell. For example, when an electrode layer 4, 6 is printed onto a medium, the medium may be a current collector layer 12, 14, or an electrolyte layer 10. When an electrolyte layer 10 is printed onto a medium, the medium may be an electrode layer 4, 6. In any of the above cases the medium may alternatively be a carrier layer that does not form part of a cell.

### Active Material Layer

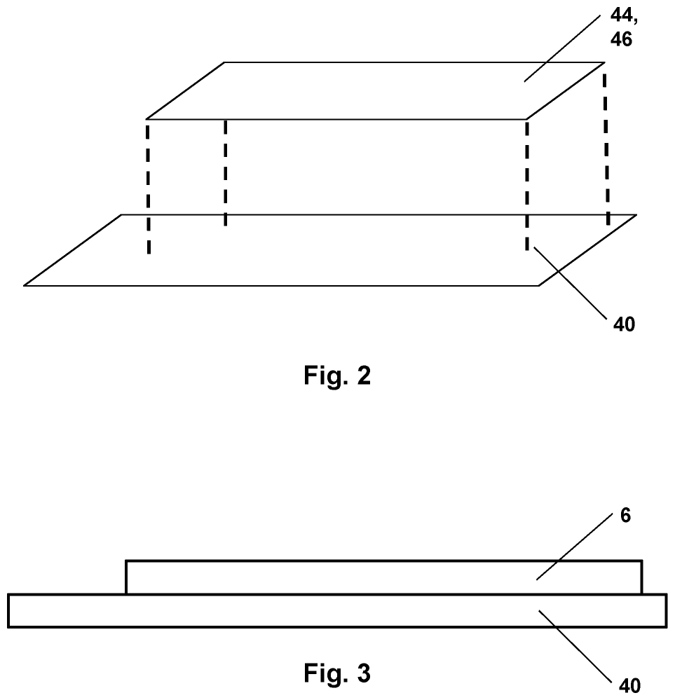

Referring to FIGS. 2 and 3, to make an active material layer, an active material ink 44, 46 is printed onto a medium 40 as shown in FIG. 2. The active material ink 44, 46 is allowed to dry or cure to produce an active material layer 4, 6 on the medium 40, shown in FIG. 3.

In this example, the active material layer 4, 6 takes the form of an electrode, which may correspond to the positive electrode 4 or negative electrode 6 of FIG. 1. The active material ink 44, 46 therefore takes the form of an electrode ink, which may correspond to a positive electrode ink 44 or a negative electrode ink 46.

Considering the electrode ink in more detail, the electrode ink comprises a solvent and an active-layer-forming material for forming an active layer. The active-layer-forming material comprises an active material in suspension in the solvent and a polymeric binder.

In this example, the active-layer-forming material is an electrode-forming material for forming an electrode. The active material is therefore an electrode material that is capable of acting as an electrode in the electrode layer.

The active material takes the form of a particulate material comprising a plurality of discrete particles. In this context ‘discrete particles’ encompasses any size or shape of material, including for example general particulate (i.e. particles of a three-dimensional geometry, which may be of generally spherical shape, or may be of other assorted and/or random shapes), flakes, or fibres.

The particles are in suspension in the solvent. In other words, the particulate matter is not soluble in the solvent.

The particles have a particle size that is less than 20 microns, and preferably less than 10 microns. In this context, the particles have a size less than a given threshold if at least 90% of particles have all dimensions less than the given threshold. For example, the active material has a particle size less than 20 microns if 90% of the particles have all dimensions less than 20 microns (referred to in the art as D90<20 microns). Particle size is measured according to Example 1 below.

A particle size of less than 20 microns has been found to be particularly beneficial in permitting printing of the electrode ink at fast printing speeds. Fast printing speeds are recognised in the art as speeds of at least 10 metres per minute. Fast printing speeds of this sort are used in high-speed printing methods such as flexographic printing, rotary screen printing, rotogravure printing or reel-to-reel printing. A particle size of less than 10 microns has been found to give particularly good quality electrodes at these fast printing speeds and using these high-speed methods.

The ink has a viscosity in the range of approximately 50 to approximately 500 centipoise when measured at a shear rate of 1000 to 100,000 s⁻¹. This is a relatively low viscosity for a printed ink. This viscosity range has been found to be beneficial when used with the high speed printing methods described above. If the viscosity is lower, the ink will not adhere well to the printing surface. If the viscosity is higher, the ink will not be transferred to the medium sufficiently quickly. Viscosity is measured according to Example 2 below.

A combination of the described particle size and viscosity has been found to be particularly effective for use in high-speed printing of electrodes, and even for use in ultra high-speed printing, which is typically considered to be speeds of at least 50 metres per minute.

The resulting electrode is flexible and conformable and, as such, is suitable inclusion into a variety of applications of an electrochemical cell 2, including low power, conformable and disposable applications in wearable technology, smart packaging, and discrete environmental sensing devices, more of which will be described below.

The components of the electrode ink will now be considered in more detail.

### Electrode Material

The electrode material may be any material capable of producing electrons, i.e. an electrochemically active species. In this way, the electrode 4 formed by such species is subsequently also electrochemically active. For such electrodes, electrolytic ions from the electrolyte 10 are able to reduce the active species thereby allowing for an electrical current to pass across the electrochemical cell 2. Such electrodes are suitable for many kinds of electrochemical cell including but not limited to a fuel cell, a lithium ion cell, an alkaline cell, and a capacitor.

A particularly preferred electrode material is an inorganic lattice material. In one example the inorganic lattice material is Manganese oxide. The skilled person appreciates that many crystallographic structures are suitable in an electrochemical cell, for instance polymorphs alpha, beta and gamma. Further, different polymorphs can provide benefits in different instances, for example, alpha has larger pores and is therefore favourable for secondary electrochemical cells and gamma provides a higher open circuit potential and a higher theoretical capacity.

Further the skilled person also appreciates that many other alternative lattice materials are suitable in an electrochemical cell depending on the nature of the cell. For example, potential electrode materials could include, but are not limited to, manganese dioxide or zinc for alkaline batteries, Lithium Colbalt Oxide (LCO) or Lithium Iron Phosphate (LFP) or graphite for lithium batteries, nickel hydroxide or cadmium for nickel-metal hydride batteries, silver oxide or zinc for silver oxide batteries. Other oxygen reduction catalysts or layered metal oxides may also be used.

The specific shape of the particles of the electrode material may be selected according to a particular application or particular cell requirements. Combinations of shapes may also be used.

It may be favourable for the particles of the electrode material to take the form of micro-sized or nano-sized particles of generally spherical shape. It may be particularly favourable for such particles to be of substantially uniform size (i.e. differing in size by no more than one order of magnitude larger and smaller than the median particle size, D50). Such particles can be close-packed to form a dense and uniform distribution of the electrode material within the electrode layer once the layer has been dried or cured. This gives particularly good compatibility with the high speed printing methods described.

The intrinsically efficient use of space in such close-packed particle arrangements is advantageous as it facilitates greatly reduced electrode thickness while still ensuring good conductivity and a large number of sites for reduction to occur. The particles may have different morphologies which can fit together in an ordered or un-ordered close-packed array.

In other situations it may be favourable for the particles of the electrode material to take the form of flakes. Flakes will allow for additional electrochemically active sites owing to the inherent increased surface area.

The electrode-forming material comprises between approximately 40 and approximately 98 wt % electrode material, and preferably between approximately 65 wt % and approximately 90 wt % electrode material. This proportion allows for sufficient content of electrode material, which is important for achieving a sufficiently dense and continuous electrode layer, but also allows for a sufficiently low viscosity for high-speed printing.

### Solvent

The solvent is a liquid, and may be any polar or non-polar liquid, with an ability to dissolve or disperse the polymeric binder into solution or dispersion, while being removable during curing and/or drying. The solvent is selected to be compatible with high-volume printing methods.

Preferably the solvent is selected to be quickly removed during drying, to provide favourable dispersion of the solid components of the ink through intermolecular interactions, to be environmentally friendly, and to be non-hazardous.

Further, it is favourable for the solvent to be non-toxic, non-hazardous, and of a low evaporation temperature for enhanced compatibility with high volume manufacturing techniques.

Suitable solvents include alcohol and water.

The ink preferably comprises between approximately 30 wt % and approximately 95 wt % solvent, preferably between approximately 50 wt % and approximately 90 wt % solvent. This proportion allows for sufficient content of electrode-forming material, which is important for achieving a sufficiently dense and continuous electrode layer, but also allows provides sufficient solvent for a sufficiently low viscosity for high-speed printing.

Correspondingly, the ink preferably comprises between approximately 5 wt % and approximately 70 wt % electrode-forming material, and more preferably between approximately 10 wt % and approximately 50 wt % electrode-forming material.

The ratio of electrode-forming material to solvent dictates the thickness of the electrode 6 when the solvent is removed by drying or curing. The ratio may therefore be tuned for desired electrode thickness and/or electrochemical performance.

### Polymeric Binder

The polymeric binder is any polymeric material capable of acting as a binder to bind the electrode material together in the finished electrode. To this end, the polymeric binder is capable of forming a connected polymer network. This may be for example due to the formation of crosslinks in the polymer during curing, such that the polymeric binder comprises a cross-linkable polymer. However, it may also be due to other types of interconnection.

The polymeric binder may be a long chain polymer, short chain polymer, amorphous polymer, crystalline polymer, or cross-linked polymer, or a mixture of the above. The polymeric binder may be dissolved in the solvent, or it may form as suspension, though it is preferred that the polymeric binder is dissolved, to provide particularly even dispersion of the binder. The polymeric binder may be selected to provide a particularly favourable viscosity of the ink for example by using high or low viscosity polymers in the form of long chain fibrous networks, highly branched or thin chain polymers modifying the viscosity of the ink, and hence the resulting electrode thickness.

The polymeric binder may also be selected for particularly good compatibility with high speed printing, and/or increased adherence of the other materials in the ink.

The polymeric binder is important in providing flexibility of the resulting electrode, to allow for use in applications requiring flexible electrolytic cells. The polymeric binders can also favourably aid in the adhesion of the ink and electrode-forming substances to the medium.

Suitable polymeric binders include polyvinyl alcohol, polyacrylamide, polyacrylic acid, polyethylene glycol, polyamines, polyvinylpyrrolidone and methyl cellulose. Further the polymeric binder may be comprised of more than one of the aforementioned polymers or others.

In some examples the polymeric binder may be a conducting polymer. This may be preferred to provide particularly good electrical conduction across the electrode layer.

The electrode-forming material preferably comprises up to approximately 40 wt % binder, preferably between approximately 5 wt % and approximately 20 wt % binder.

### Other Optional Components of the Active-Layer-Forming Material

The active-layer forming material may also optionally comprise any of the following alone or in combination: a conductive material, a dispersion agent, an inert filler, and/or another additive, such as an anti-drying agent, defoaming agent and/or emulsifier.

### Conductive Material

A conductive material additive may be used to improve conductivity of the electrode. For such electrodes there is conductivity is through the thickness of the electrode, allowing for particularly effective extraction of current via the current collector 12 for coupling with the electrode 4 and current collector 14 to power a device (not shown).

Suitable conductive additives include particles that may take the form of general particulates, fibres or flakes that are made of a conductive material. Particularly preferred materials are carbon additives, including carbon black (for example in the form of acetylene black particulates), graphite (for example in the form of graphite flakes), carbon nanotubes (for example in the form of single wall carbon nanotubes or multi wall carbon nanotubes).

The conductive materials are tuneable depending on the additive used. For instance small particulate spherical species will allow for the formation of a conductive carbon network allowing for connection to the current collector 12 and for transfer of electrons. However, carbon flakes, for instance, could overlap in the electrode 4 owing to the formation of an alternative conductive carbon network. Further this could result in conductivity across the length of the electrode 4 in addition to the through thickness conductivity.

Additionally, it is favourable for the conductive additive, to be of a consistent spherical particulate morphology for increased compatibility with high volume manufacturing methods, more specifically flexographic or reel to reel printing techniques. Further alternative conductive additives can be printed via these methods.

Preferably the electrode-forming material comprises up to approximately 40 wt % conductive material, most preferably between approximately 5 wt % and approximately 20 wt % conductive material.

### Dispersion Agent

A dispersion agent may be used to provide an electrode 4 of particularly high uniformity and consistency. For such electrodes the dispersion agent will bind to the electrode material and/or the conductive additive and/or the polymeric binder and/or the inert filler resulting in homogeneity during high volume manufacturing methods in the form of a solution or colloid. Using a dispersion agent can also improve repeatability of performance, consistency during printing, improved manufacturability.

The dispersion agent may be amphiphilic, hydrophobic or hydrophilic in nature.

The electrode-forming material may comprise up to approximately 5 wt % dispersion agent, preferably between approximately 0.1 wt % and approximately 1 wt % dispersion agent.

### Inert Filler

The electrode-forming material may also comprise an inert filler. An inert filler can be used to vary the electrode structure to allow, for example, an increased surface area and or access to the electrochemically active species of the electrode material.

The inert filler may take the form of a discrete solid material, for example particles in the form of general particulate, fibres or flakes suspended in the solution in the form of a mixture or a suspension. In the context ‘inert’ means that the species are not electrochemically active in the cell. Using an inert filler is advantageous in forming a favourable structure in the electrode to improve electrochemical performance.

The electrode-forming material may comprise up to approximately 50 wt % inert filler, preferably up to approximately 10 wt % inert filler.

### Other Additives

Other possible additives include, anti-drying agents, defoaming agents, emulsifiers, and others.

### Other Optional Components of the Ink

The ink may additionally comprise an electrolyte material. The electrolyte may form a solution in the solvent. In this way, the electrode 4, once printed, already hosts at least some of the electrolytic ions from the electrolyte 10. This beneficially negates the need for any additional step of providing a suitable electrolyte 10 to the electrode 4 after it is formed.

### Particular Examples of Electrode Inks

In a particular example of a positive electrode ink, the ink may comprise manganese dioxide particles, a carbonaceous material, an alcohol-based polymeric binder and an alcohol solvent in which the other components may be dispersed. In other embodiment, the particles of manganese dioxide particles could instead be NiOOH, other metal hydrides, Ag₂O.

In a particular example of a negative electrode ink, the ink may comprise zinc particles, an alcohol-based polymeric binder and an alcohol solvent in which the other components may be dispersed. In other embodiments, the zinc particles could instead be any easily reducing metal, such as lead.

### Methods of Making the Electrode Inks

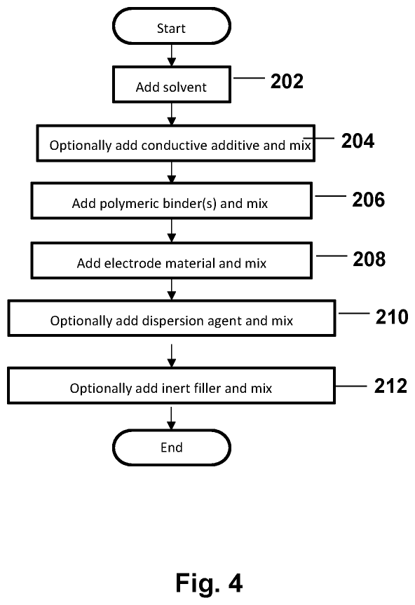

The method of making the ink will now be described with reference to FIG. 4. In this example the electrode-forming material includes an electrode material and a polymeric binder as well as the optional components of a conductive additive, dispersion agent and filler.

In the first step 202, a solvent is chosen as the bulk ink component. This solvent is chosen such that the electrode material and the conductive additive can be dispersed in suspension to form the basis of an electrode ink compatible with printing. This solvent is also chosen such that the polymer binder can be dispersed and/or dissolved into solution to aid in the formation of electrode 4.

Optionally and secondly in step 204, the conductive additive is added to the solvent. The formed ink is mixed to improve homogeneity and uniformity in the suspension.

Thirdly in step 206, one or more polymeric binders are added to the ink. The formed ink is mixed to improve homogeneity and uniformity in the suspension.

Fourthly in step 208, the electrode material is added to the ink. The formed ink is mixed to improve homogeneity and uniformity in the suspension.

Optionally and fifthly in step 210, a dispersion agent is added to the ink and the ink is mixed. This may, for example, be bound to the active species, polymeric binder, the conductive additive or the inert species in the ink to promote homogeneity in the form of a solution or colloid.

Optionally and finally in step 212, an inert filler is added to the ink and the ink is mixed. This will, for example, improve the rigidity and/or structural strength of the formed electrode.

It should be appreciated that the components may be added in a different order to the order described above

### Methods of Printing the Electrodes

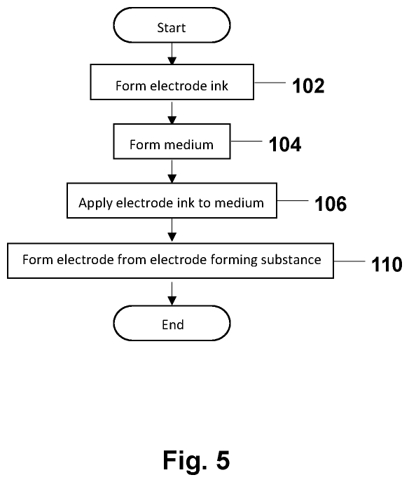

The method of printing the ink will now be described with reference to FIG. 5.

In the first step 102, the electrode ink 4, 6 is provided. Providing the ink may comprise making the ink according to the method above.

In the second step 104 the medium is provided. The medium is the component on which the ink is to be applied and the electrode 6 is to be printed.

As explained above, the medium can be any suitable medium 40 such as a substrate. The medium 40 may, for example, be an electronically insulating or conductive material; for example a sheet of a fabric, a polymer, a glass, a paper, a metal, or a ceramic. After the electrode 4 is printed and fully formed on the medium 40, it could optionally be removed therefrom for use within an electrochemical cell manufactured in a separate process.

Alternatively, the medium 40 could be another component of an electrochemical cell 2. Indeed, this other component may itself have been printed and could also include electronic circuits. This will be described in more detail below.

In the third step 106 the electrode ink is printed.

In step 106, the ink is applied to the medium 40 in a printing process, which is preferably a high-speed printing process having a printing speed of at least 10 meters per minute. Any suitable printing process may be used such as screen-printing, stencilling, flexography, gravure, off-set and ink-jet printing, or reel-to-reel printing. Such printing processes allow thin layers of ink to be applied to the medium so that thin electrodes 4 may be formed.

The ink is typically printed in a layer that is no more than 100 microns in thickness. It will be appreciated that the final electrode layer will have a lesser thickness, because some of the ink material will be lost due to evaporation of the solvent in subsequent stages. In particularly preferred embodiments the ink is printed with a thickness that is no more than 20 microns.

In the final step 108 of the process the electrode 4 is formed on the medium out of the electrode-forming material in the printed layer of ink.

To form the electrode 4 from the printed layer of ink, the ink can be dried and/or cured, for example, using a heater or a laser. The drying or curing step performs several functions.

Firstly, drying causes the solvent or any other liquid or gel in the ink may be evaporated such that only the particles of electrode-forming substance are left on the medium to form the electrode.

Secondly, curing causes the polymeric binder to cure. This curing process causes the polymeric binder to form a connected polymer network. This may be for example due to the formation of crosslinks in the polymer, but it may also be due to other types of interconnection. Curing the polymer binder in this way causes a change in the viscosity so that the ink becomes solid or gel-like after curing to form the electrode.

The curing process may replace or supplement any drying of the ink.

In cases where the morphology of the particles of electrode material in the ink support the formation of a close-packed array, the ink is almost completely cured or dried, so that there is no uncured or un-dried ink left in the formed electrode 4. Removal of any uncured or undried ink can be promoted for example, by using a heater or a laser. However, it is likely that some uncured or undried ink will remain within the structure of the electrode 4, coating the particles, to facilitate the retention and movement, in use, of the electrolytic ions.

If the printed thickness of the ink is insufficient to provide an electrode of the required thickness, the printing step 106 can be repeated before or after carrying out the forming step 110. This can build up the printed ink to the desired thickness before forming the electrode. It will be appreciated that the printing step 106 could also be repeated after the forming step 110 has taken place, but it is more time-efficient to conduct the forming step at the end of the process when all required layers have been printed.

The skilled person appreciates that this method could be extended to a wide range of electrochemical cells and, for instance, increase the electrode capacity, or used to manufacture alternative thicker electrically conductive components.

Each of the positive and negative electrode inks can be exposed to a post-printing treatment to improve its functionality, which can include laser sintering, heat sintering, and intermittent pulsed light sintering.

### Printed Electrolyte Layer

The electrolyte ink and resulting electrolyte layer will now be described in detail.

Although this part of the disclosure relates to an electrolyte for a thin film electrochemical cell, and in particular to a method of printing of such an electrolyte, the skilled person will appreciate that the described method is equally suited for printing electrolytes for use in all types of electrochemical cell.

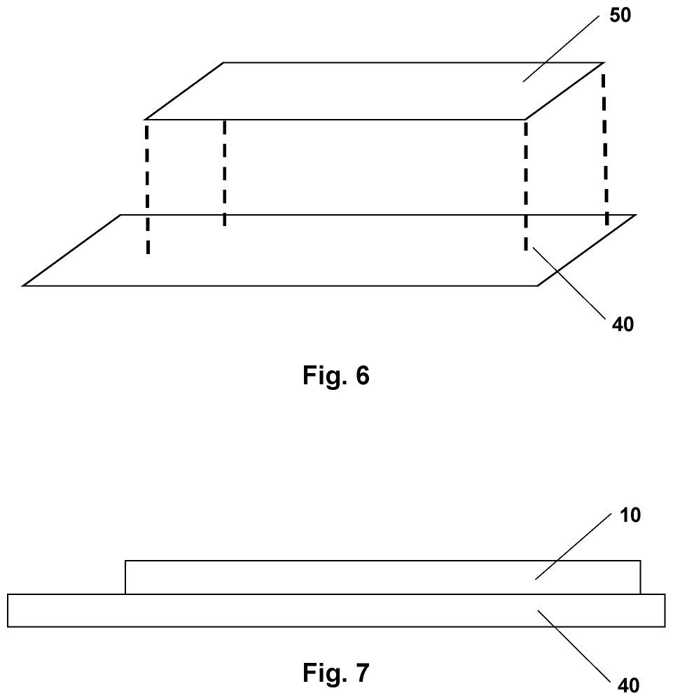

Referring to FIGS. 6 and 7, to make an electrolyte layer, an electrolyte ink 50 is printed onto a medium 40 as shown in FIG. 6. The electrolyte ink 50 is allowed to dry or cure to produce an electrolyte layer 10 on the medium 40, shown in FIG. 7.

Considering the electrolyte ink 50 in more detail, the electrolyte ink 50 comprises a solvent and an electrolyte-forming material for forming the electrolyte layer 10. The electrolyte-forming material comprises an electrolyte species and a polymer.

The electrolyte ink has a viscosity in the range of approximately 50 to approximately 500 centipoise when measured at a shear rate of 1000 to 100,000 s⁻¹. This is a relatively low viscosity for a printed ink. This viscosity range has been found to be beneficial when used with the high speed printing methods described above. If the viscosity is lower, the ink will not adhere to the printing surface. If the viscosity is higher, the ink will not be transferred to the medium sufficiently quickly. Viscosity is measured according to Example 2 below.

The polymer is a gel polymer that is capable of forming a connected polymer network, for example by crosslinking. As a result, the resulting electrolyte is flexible and conformable and, as such, is suitable inclusion into a variety of applications of an electrochemical cell 2, including low power, conformable and disposable applications in wearable technology, smart packaging, and discrete environmental sensing devices, more of which will be described below.

The components of the electrolyte ink will now be considered in more detail.

### Solvent

The solvent is a liquid, and may be any polar or non-polar liquid, with an ability to host the electrolyte-forming components, while being removable during curing and/or drying. The solvent can be chosen to ensure the electrolyte species is dissolved whilst being able to host the gel polymer material, and ensuring the ink has the correct rheological properties to be printed. Suitable solvents include alcohol and water.

Further, it is favourable for the solvent to be non-toxic, non-hazardous, and of a low evaporation temperature for enhanced compatibility with high volume manufacturing techniques.

The ink preferably comprises between approximately 25 wt % and approximately 99.9 wt % solvent. This proportion allows for sufficient content of electrolyte-forming material, which is important for achieving a sufficiently dense and continuous electrolyte layer having sufficient thickness, but also allows provides sufficient solvent for a sufficiently low viscosity for high-speed printing.

The ratio of electrolyte-forming material to solvent dictates the thickness of the electrolyte layer when the solvent is removed by drying or curing. The ratio may therefore be tuned for desired electrolyte thickness and/or electrochemical performance.

### Electrolyte Species

The electrolyte species may be any electrochemically active species capable of producing ions that can act as an electrolyte. Examples are KOH, ZnCl₂, and ZnSO₄. The active material is electrochemically active with both electrodes in the electrochemical cell by enabling charge transfer between the electrodes to sustain charge neutrality during charge or discharge. The advantage of using an active material dissolved in the inks is that a separate electrolyte addition process is not required. This active material remains in the electrolyte layer after printing and drying/curing, to facilitate the electrochemical cell function.

### Polymer

In the finished electrolyte, the polymer forms a gel polymer that provides a matrix through which ions of the electrolyte species can move thereby allowing an electric current to pass through the gel polymer material. The polymer therefore comprises polymer material that is capable of forming such a gel polymer matrix on drying or curing.

To this end, the polymeric binder is capable of forming a connected polymer network. This may be for example due to the formation of crosslinks in the polymer during curing, such that the polymeric binder comprises a crosslinkable polymer. However, it may also be due to other types of interconnection.

Suitable gel polymers include carbon-backboned polymers with polar side groups. Particularly preferred gel polymers can include polyvinyl alcohol, polyacrylamide, polyacrylic acid, polycarbonate, polysulfone, polyurethane, and more. The skilled person appreciates that many other similar materials are suitable.

The polymer component of the ink may comprise a mixture of different polymer materials. Mixing polymer materials in this way can tune the viscosity and other properties of the ink and/or the finished electrolyte.

The addition of a gel polymer is advantageous as it provides a matrix through which the electrochemically active species can diffuse, whilst providing a physical separation between electrodes to prevent physical and electrical contact. The polymer content can be varied specific to the nature of the cell.

The ink can comprise between approximately 1 wt % and approximately 50 wt % gel polymer.

### Other Optional Components

The electrolyte ink may also optionally comprise any of the following alone or in combination: a crosslinking catalyst, a surfactant, and/or another additive, such as an anti-drying agent, wetting agent, defoaming agent and/or emulsifier.

### Crosslinking Catalyst

The ink may also comprise a cross-linking catalyst. Such a catalyst serves to speed up the cross-linking mechanism for the gel polymer after the ink is printed.

Suitable cross-linking catalysts include highly oxidising species such as potassium persulfate. The skilled person appreciates that many other similar materials are suitable.

When a cross-linking catalyst is used, the ink comprises approximately 0.001 wt % to approximately 1 wt % cross-linking catalyst.

### Surfactant Additive

The ink may also comprise a surfactant additive. Such a surfactant additive serves to improve the ink properties of the electrolyte.

Suitable surfactant additives include long chain anionic, cationic, non-ionic and amphoteric molecules. The skilled person appreciates that many other similar materials are suitable.

When a surfactant additive is used, the ink preferably contains approximately 0.1 wt % to approximately 10 wt % surfactant additive.

### Other Additives

Other optional additives include an anti-drying agent, wetting agent, defoaming agent and/or emulsifier. When other optional additives are used, the ink preferably contains approximately 0.1 wt % to approximately 10 wt % other optional additives.

### Methods of Making the Electrolyte Ink

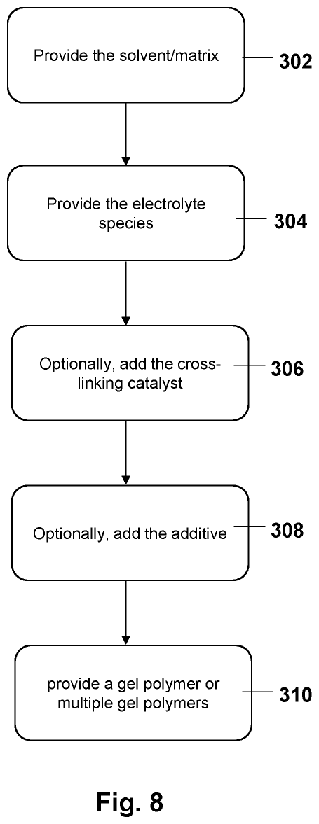

An exemplary method of making the electrolyte ink will now be described with reference to FIG. 8.

In the first step 302 the solvent is provided.

In the next step 304 the electrolyte species is added to the solvent and mixed to dissolve the electrolyte species in the solvent.

In the following step 306 the cross-linking catalyst (if used) is added to the mixture and mixed to dissolve the cross-linking catalyst in the solvent.

In the following step 308 a surfactant additive (if used) is added to the mixture. Other additives may also be added at this point. The mixture is mixed to disperse and/or dissolve additives.

In the following step 310 the gel polymer is added to the mixture. The polymer may be a pre-dispersed polymer. Once added, the gel polymer becomes impregnated with ions of the electrolytic species, so that the electrolytic species is evenly dispersed within the mixture and the gel polymer.

If the polymer comprises a mixture of multiple polymer materials then the multiple polymer materials are added at this stage, simultaneously or sequentially.

It will be understood by the person skilled in the art that the separate elements of the ink may be added in any suitable order and that the order given above is by way of example only. For example, the cross-linking catalyst may be added to the solvent after the electrolyte is dissolved in the solvent, or after the surfactant additive is added to the solvent.

### Methods of Making the Electrolyte Layer

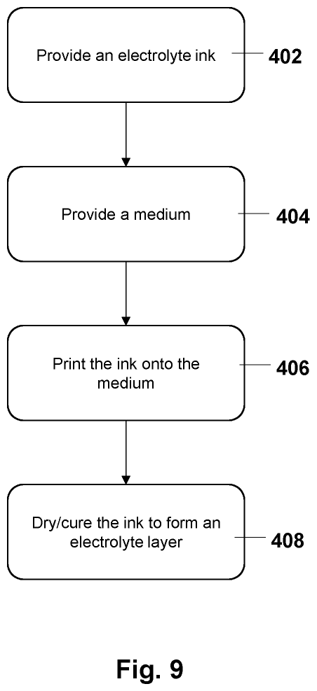

A method of making an electrolyte layer using the electrolyte ink will now be described with reference to FIG. 9.

In the first step 402, the electrolyte ink is provided. Providing the electrolyte ink may comprise making the electrolyte ink according to the method above.

In the second step 404 the medium is provided. The medium is the component on which the ink is to be applied and the electrolyte is to be printed.

As explained above, the medium can be any suitable substrate 40. The substrate 40 may, for example, be an electronically insulating or conductive material; for example a sheet of a fabric, a polymer, a glass, a paper, a metal, or a ceramic. After the electrolyte is printed and fully formed on the substrate 40, it could optionally be removed therefrom for use within an electrochemical cell manufactured in a separate process.

Alternatively, the medium could be another component of an electrochemical cell 2. Indeed, this other component may itself have been printed and could also include electronic circuits. This will be described in more detail below.

In the third step 406 the electrolyte ink is printed.

In step 406, the ink is applied to the medium in a printing process, which is preferably a high-speed printing process having a printing speed of at least 10 meters per minute. Any suitable printing process may be used such as screen-printing, stencilling, flexography, gravure, off-set and ink-jet printing, or reel-to-reel printing. The ink is preferably applied to a printing surface using a bar coater. Such printing processes allow thin layers of ink to be applied to the medium so that thin electrodes 6 may be formed.

The ink is typically printed in a layer that is no more than 100 microns in thickness. It will be appreciated that the final electrode layer will have a lesser thickness, because some of the ink material will be lost due to evaporation of the solvent in subsequent stages. In particularly preferred embodiments the ink is printed with a thickness that is no more than 20 microns.

In the final step 108 of the process the electrolyte is formed on the medium out of the electrolyte-forming material in the printed layer of ink.

To form the electrolyte 6 from the printed layer of ink, the ink can be dried and/or cured, for example, using a heater or a laser. The drying or curing step performs several functions.

Firstly, drying causes the solvent or any other liquid in the ink to be evaporated such that only the electrolyte-forming substance is left on the medium to form the electrolyte.

Secondly, curing causes the polymer to cure to form the gel matrix of the electrolyte. This curing process causes the polymer to form a connected polymer network. This may be for example due to the formation of crosslinks in the polymer, but it may also be due to other types of interconnection. Curing the polymer in this way causes a change in the viscosity so that the electrolyte becomes gel-like after curing.

The curing process may replace or supplement any drying of the ink.

By using an ink that comprises the aforementioned gel polymer, the method of the invention is able to produce electrolytes that are robust to penetration from dendritic growth and from external articles which might damage the electrochemical cell. As such, even when the electrolyte is very thin, for example less than 20 microns or even less than 10 microns, it is resilient to being broken or punctured (for example, by dendrites e.g. zinc particles that may build up on the anode). This may allow the separator to be omitted from the cell.

Moreover, despite this increased toughness, the electrolyte is flexible and conformable and, as such, is suitable for a variety of applications of an electrochemical cell, including low power, conformable and disposable applications in wearable technology, smart packaging, and discrete environmental sensing devices, more of which will be described below.

Finally, due to the simplicity of the process, it is possible to manufacture electrolytes 8 quickly and with ease.

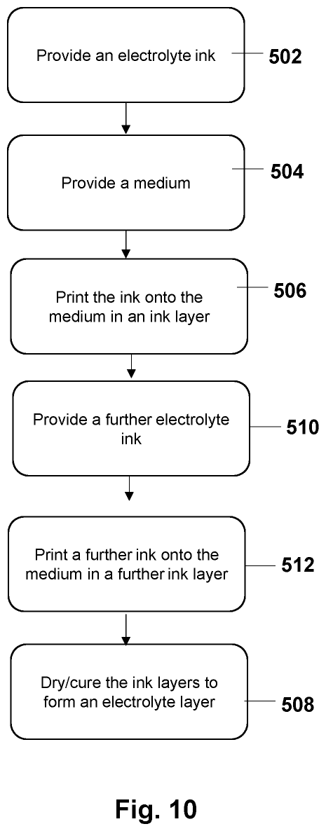

FIG. 10 illustrates an example method in which multiple inks are used

The initial steps of providing an electrolyte ink 502, providing a medium 504 and printing the ink onto the medium 506 are substantially the same as the method of FIG. 9.

However, according to this method, in additional steps 510, 512, a further electrolyte ink is provided in step 510 and a further electrolyte ink layer is printed onto the medium over the original electrolyte layer in step 512. The electrolyte layer and the further electrolyte layer are then dried or cured together to form an electrolyte layer in step 508.

According to this method, the ink and the further ink comprise different polymers. The different polymers can be selected to provide beneficial effects. For example the different polymers may provide different physical or electrochemical properties. The different polymers may also be selected to react with each other at an interface between the layers.

The inks may have other components that are different: for example different cross-linking catalysts and other additives.

Using multiple inks comprising multiple polymers in this way, inks can be successively printed with differing degrees of drying/curing after each print to form varying thicknesses and degrees of cross-linked polymer networks. This increases the resilience to failure of the electrochemical cell, and allows for substantial solidification of the electrode after printing.

### Methods of Making Electrolytic Cells

The methods of making electrode layers and electrolyte layers as described above can be use alone or in combination as part of a process of making a part or a whole of an electrolytic cell. Examples of such processes will now be described.

According to a first example, the electrolytic cell is a fully-printed cell that is printed as a stand-alone cell component.

A first medium is provided in the form of a current collector layer. A first electrode layer is then printed onto the current collector layer according to the methods described above: a first electrode ink is printed onto the current collector layer and is then dried or cured to form the first electrode. In this example, the first electrode is a positive electrode.

The printed first electrode then forms the medium onto which an electrolyte layer is printed, using the method described above: an electrolyte ink is printed onto the first electrode layer and dried or cured to form the electrolyte.

The printed electrolyte then forms the medium onto which a second electrode layer is printed, using the method described above: a second electrode ink is printed onto the electrolyte layer and is then dried or cured to form the second electrode. In this example, the second electrode is a negative electrode.

A current collector layer is then arranged over the second electrode to complete the electrolytic cell.

By printing each of part of the electrochemical cell one on top of the other, this method can produce an entire electrochemical cell using a single printing device. This allows cells to be printed reel-to-reel using conventional printing techniques. Alternatively, the separate layers of the electrochemical cell may be printed by separate printing devices.

The current collector layers may themselves be printed layers. In other examples, the current collector layers may be omitted.

In a second example, the cell may be a fully printed cell that is printed directly onto the flexible surface of an article into which the cell is to be incorporated. In this case the initial medium onto which the first electrode is printed may be a substrate intended for use in the final product such as clothing, a wearable device or any other product suitable for use with a printed electrochemical cell. Other printing stages may be substantially the same as that of the first example.

The benefit of the above described methods is that a complete electrochemical cell can be printed onto a single substrate without interruption or the need to move the substrate between printing devices.

In a third example, the cell may be a partially printed cell.

In a first step, a first electrode is printed on a substrate in accordance with the methods described above. Thereafter, an electrolyte is then printed on the first electrode in accordance with any of the process for printing an electrolyte as described above. In the final step, a second electrode is delaminated onto the electrolyte to form the electrochemical cell. This allows a second pre-manufactured electrode to be placed in position, where manufacturing of the second electrode would be difficult in a printing line. Alternatively, a separator material may be delaminated onto the first electrode, and the electrolyte printed onto the separator material.

Examples are also envisaged in which both the electrodes are delaminated electrodes.

Each of the above-described processes for printing an electrochemical cell may also include a step of printing a protective cover over the first current collector, the first electrode, the electrolyte, the second electrode and/or the second current collector. For example, the protective cover may be printed directly over the first and second current collectors and the electrolyte. In the case of including a delamination of one or both of the electrodes, the protective cover may be in the form of the substrate of a second electrode which is also delaminated onto the substrate of the first electrode. The protective cover is preferably electrically insulating and serves to seal the electrical components of the electrochemical cell within the protective cover while allowing access to the current collectors and/or the electrodes for electrical connection.

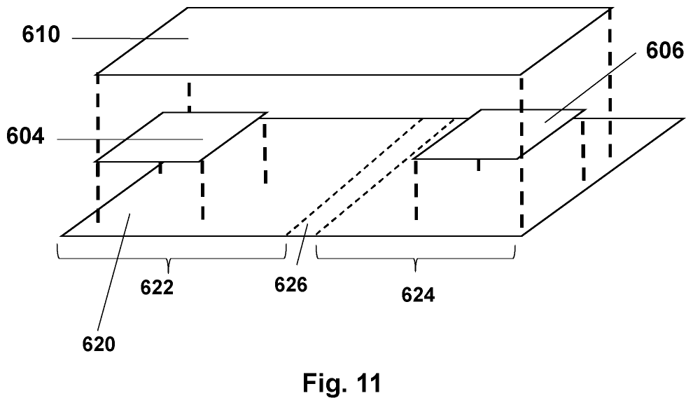

An alternative example process for printing an electrochemical cell will now be described with reference to FIG. 11 which shows an embodiment of a printed complete electrochemical cell.

In this example, the medium is a substrate 620 that comprises first 622, second 624 and third portions 626. The first and second portions 622, 624 are preferably close to, but not bordering, each other. A third portion 626 extends between the first and second portions 622, 624 so that the first and second portions 622, 624 are arranged away from one another on either side of the third portion 626. As shown in FIG. 11, each of the first and second portions 622, 624 can take up one of two ends of the substrate 620, while the third portion 626 can include the middle section extending between the two ends. The skilled person however appreciates other suitable and appropriate arrangements are possible.

In the first step of this process, a first electrode 604 is printed on the first portion 622 of the substrate 620 and in the second step the second electrode 606 is printed on the second portion 624 of the substrate 620. The skilled person appreciates that these electrodes could be printed in any order or even simultaneously. Because of the arrangement of the first and second portions 622, 624, a gap is formed between the first and second electrodes 604, 606, thereby preventing contact of the first and second electrodes 604, 606 in use.

In the third step, and as shown in FIG. 11, an electrolyte 610 is printed over both the first and second electrodes 604, 606 and over the third portion 626 of the substrate 620. Therefore, in this example embodiment, the medium referred to in the above-described printing processes takes the form of both the printed first and second electrodes 604, 606, and the third portion 626 of the substrate 620. In this example, a single electrolyte forms a continuous electrolyte layer 610. The fourth step comprises folding the substrate over itself such that the second electrode 604 is arranged over the first electrode 606. In this way, the electrochemical cell takes the form of a pouch. If desired, the substrate 620 could be removed from the electrochemical cell.

If current collectors are also to be provided, the process may also include printing a first current collector on the first portion of the substrate and printing a first electrode on the first current collector. Additionally or alternatively, the process may include printing a second current collector on the second portion of the substrate and printing a second electrode on the second current collector. The skilled person appreciates that these steps may be undertaken in any appropriate order.

An alternative may include delaminating solid forms of one or both electrodes onto the substrate. An example of a solid form of an electrode is a thin foil of metal. The skilled person however appreciates other suitable and appropriate forms are possible.

In an alternative example, the first and/or second electrodes or the first and/second current collectors, may be provided pre-formed and applied to the substrate (or current collectors) using any suitable processes. When first and/or second current collectors are provided they may constitute the substrate upon which the electrochemical cell is printed. Moreover, instead of printing the electrolyte on the first and second electrodes, the electrolyte may be printed on a separate substrate and then removed from the substrate and arranged over the first and second electrodes. In such an embodiment, the electrochemical cell may therefore be described as partially printed. Likewise, the current collectors may be provided pre-formed and applied to the substrate using any suitable process.

It should be noted that regardless of how the different components are arranged, it is necessary that each of the first and second electrodes, or each of the first and second current collectors (if used), remain connectable to an electrical device (not shown). So long as this is ensured, the components of the electrochemical cell can be stacked and overlaid in any suitable way. Indeed, the skilled person appreciates the many possible variants of this.

In cases where the electrochemical cell does not include current collectors, it may be desirable to print the components such that the electrolyte is not exposed to the outside at all in the formed electrochemical cell. Likewise, if the electrochemical cell is to include current collectors, it may be desirable to print the components of the electrochemical cell such that the electrolyte and the first and second electrodes are not exposed to the outside at all in the formed electrochemical cell.

To print any of the electrodes, the current collectors or the protective covers described above a suitable ink must be provided. Thereafter, the ink is applied to a substrate or to another component of the electrochemical cell using any suitable printing process such as screen-printing, stencilling, flexography, gravure, and off-set and ink-jet printing. Finally, the electrode, the current collector or the protective cover is then formed from the applied ink by e.g. drying or curing the ink as appropriate.

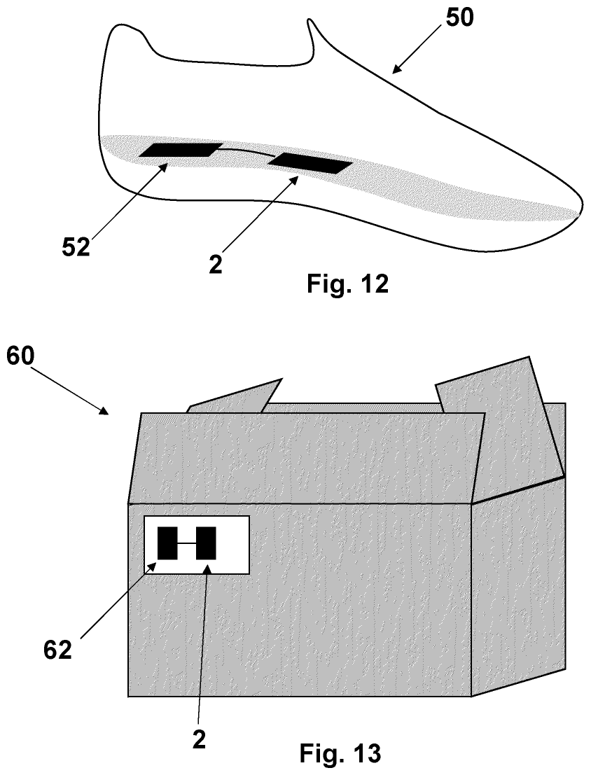

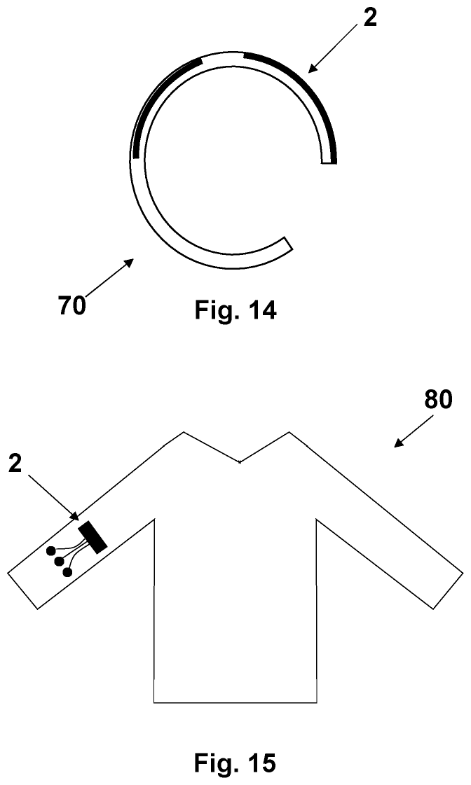

Electrochemical cells made according to any of the above methods can be used to store and supply energy from an energy harvesting device. As shown in FIG. 12, the electrochemical cell 2 is used to store and supply energy from a piezoelectric device in article of footwear 50. To this end, the electrochemical cell and the piezoelectric device are installed in, and preferably within a sole 52 of the footwear 50, and are coupled together using a conventional means.

Likewise, the electrochemical cell can be used to provide power for smart packaging. As shown in FIG. 13, an article of packaging 60 is provided with a smart device 62 and such an electrochemical cell 2 configured to provide power to said smart device 62. In one embodiment, the smart device 62 takes the form of an environmental logging device, i.e. a device configured to measure information about the environment (e.g. temperature) of (e.g. the inside) of the packaging. Additionally or the alternatively, the smart device 62 may take the form of a radio-frequency identification device.

The electrochemical cell 2 may also be incorporated into other wearable smart device such as a smart watch 70 shown in FIG. 12, or an article of clothing 80 shown in FIG. 15.

### EXAMPLES

### Example 1—Particle Size Measurement

A particle size measurement was conducted using the Malvern Mastersizer 3000

Particles were dispersed in a solvent to less than 10 volume %. Parameters such as refractive index and particle shape of the material were known and inputted into the Mastersizer. The obscurity range was greater than 30%. A three fold differential light scattering method of red, green and blue (of visible wavelength) was used, between a range of 10 nm and 1 mm. The particle size measurement was undertaken at room temperature using a similar solvent to that used in the ink. An average of three measurements was taken for the D10, D50 and D90 values.

The D90 value was used as an assessment of maximum particle size.

### Example 2—Viscosity Measurement Measurement

Viscosity is measured using a shear plate-on-plate rheometry from 0.1 μN·m to 500 μN·m directly after mixing at 2000 rpm for 1 minute, and using a shear rate ranging from 1000 to 100,000 s⁻¹.

### Instruments:

DAC150 Speedmixer
TA Instruments HR-30 Rheometer

The test specimen was spun before testing on the Speedmixer for 1 minute at 2000 RPM. The specimen was then taken straight to the Rheometer for testing where the upper 40 mm parallel plate and lower Peltier plate performed experiments at 20 degrees Celsius.

The ink was poured onto the TA Instruments Peltier plate at 20 degrees Celsius and a 40 mm Parallel plate arranged on top. The test was carried out for 60 seconds, with a 60 second soak time to let the sample recover after pouring. Torque will be applied to the inks from 0.1 μN·m to 500 μN·m.

Viscosity was assessed in the shear rate ranging from 1000 to 100,000 s⁻¹.

### Example 3—Electrolytic Cell

An example of printing an electrochemical cell is given below. The example incorporates methods of printing electrolyte layers and methods of printing electrode layers.

### Ink Compositions and Properties

### Positive Electrode Ink:

Carboxymethylcellulose (CMC) and styrene-butadiene rubber (SBR) in a mass ratio of 1:1 are dispersed in distilled water.

Carbon black (CB) and manganese dioxide (MnO₂) particles are then added to the solution which is mixed until homogenous. The D90 measurement of the MnO2 particles was 12.7 microns, measured according to the method of Example 1.

The mixture is finally subjected to ultrasonic waves to ensure homogeneity.

The final mixture contains MnO₂ to CB to CMC to SBR in a 85:5:5:5 mass ratio. The solid particles comprises less than 50 volume % of the mixture. The proportion of distilled water in the ink was 50%.

The viscosity of the ink was approximately 200 cps.

### Negative Electrode Ink:

Carboxymethylcellulose (CMC) and styrene-butadiene rubber (SBR) in a mass ratio of 1:1 are dispersed in distilled water.

Zinc particles are then added to the solution which is mixed until homogenous. The mixture is finally subjected to ultrasonic waves to ensure homogeneity. The D90 measurement of the zinc particles was known to be less than 1 micron.

The final mixture contains Zn to CMC to SBR in a 90:5:5 mass ratio. The solid particles comprises less than 20 volume % of the mixture. The proportion of distilled water in the ink was 50%.

The viscosity of the ink was approximately 200 cps.

### Electrolyte Ink:

Potassium hydroxide (KOH) is dissolved in distilled water to form a 6M solution.

Potassium persulfate is dissolved in distilled water.

Polyvinyl alcohol (PVA) is dissolved in distilled water to form a 5 mass % of the mixture. The final mixture contains PVA to KOH to Potassium persulfate to distilled water in the mass ratio of 5:5:0.25:89.75.

The viscosity of the ink was approximately 200 cps.

### Making the Electrolytic Cell

A foil of nickel is provided, which serves as the first current collector. An adhesive copper layer is provided, which serves as the second current collector.

The positive electrode functional ink is applied to a layer of the nickel foil using a flexographic coating method. A layer with a solid thickness less than 20 μm is deposited. The layer is then dried in an oven at a temperature 80° C. until the positive electrode is formed.

The electrolyte ink is then applied to the fully cover the positive electrode. A layer with a solid thickness less than 50 μm is deposited. The layer is then dried in an oven at a temperature 80° ° C. to form the electrolyte.

The negative electrode ink is then deposited on top of the electrolyte layer. It is important to prevent the negative electrode ink from contacting the positive electrode layer and the nickel foil. A layer with a solid thickness less than 20 μm is deposited. The layer is then dried in an oven at a temperature 80° C. until the negative electrode is formed.

Finally, a layer of the adhesive copper is applied on top of the negative electrode. It is again important to prevent the adhesive copper from contacting the positive electrode layer and the nickel foil.

### Cell Properties

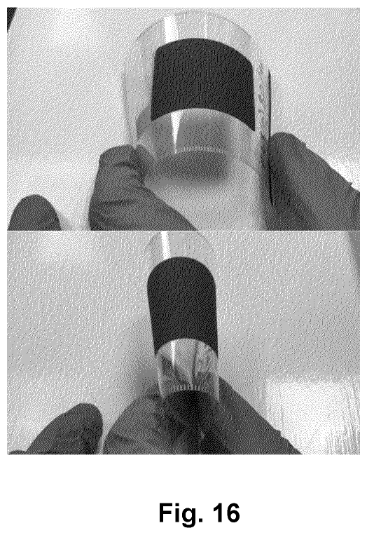

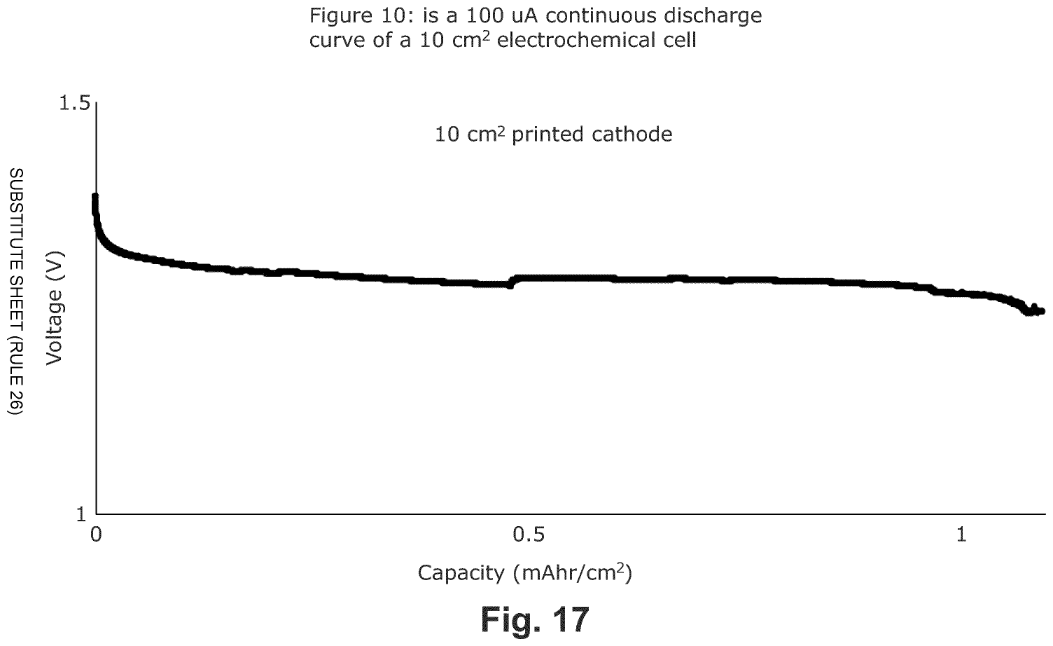

FIG. 16 shows the electrochemical cell of this example with the first electrode printed and cured. The electrode displays good flexibility and hence is well suited for a variety of applications.

FIG. 17 shows a 100 μA discharge curve of the fully printed electrochemical cell of 10 cm2, which uses a cathode of MnO2, polymeric binder, conductive carbon in a ratio 85:10:5, an electrolyte of PVA/KOH gel electrolyte, and an anode of Zn, polymeric binder in a ratio of 90:10. A nickel foil was used as the cathode current collector, and adhesive copper used as the anode current collector.

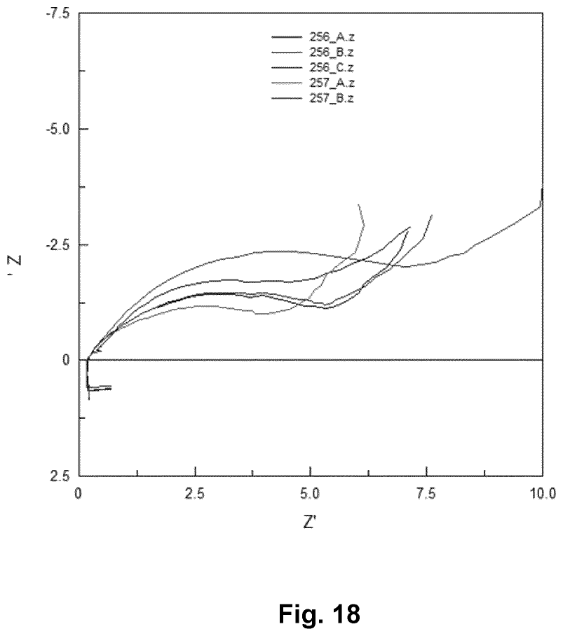

FIG. 18 shows an electrochemical impedance spectra applying a 10 mV AC sinusoidal voltage at frequencies between 105 and 10-1 Hz, for the printed cells with two cathode variations 256, 257 and three electrolyte variations A,B and C. The cathodes were composed of MnO2, polymeric binder and conductive carbon in an 85:10:5 ratio (256) and 90:5:5 ratio (257). The electrolytes A, B and C were composed respectively of PVA in 2.5 wt %, 5 wt % and 7.5 wt % mass loadings in solvent of 1M KOH.

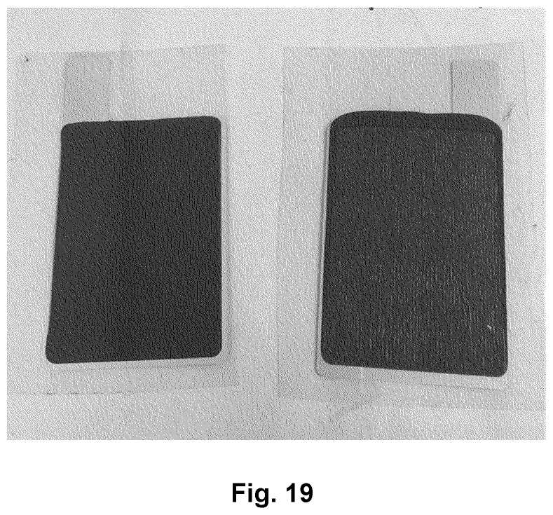

FIG. 19 shows two electrodes that have been printed on a current collector in accordance with described methods. The left electrode contains an electrode material having particles of suitable size, for example, less than 20 microns allowing for a consistent, uniform print during high volume manufacture. The right electrode contains contains an electrode material having particles of unsuitable size, for example, in excess of 20 microns, resulting in an inconsistent, variable print during high volume manufacture.

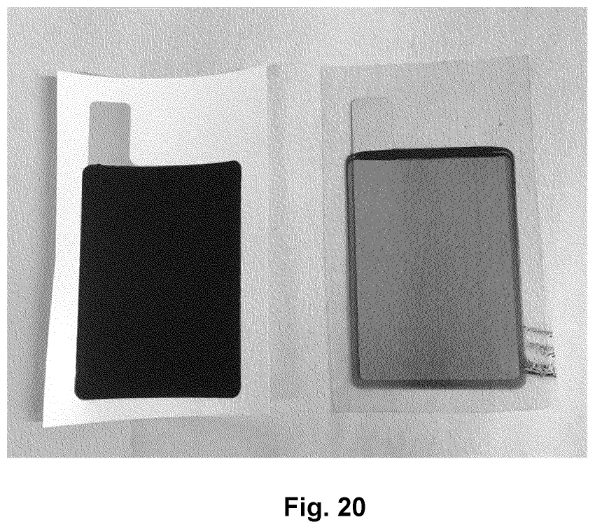

FIG. 20 shows two electrodes that have been printed on a current collector in accordance with described methods. The left electrode contains a polymeric binder of suitable properties that results in a favourable viscosity of the ink between 50 and 500 cps and provides a uniform print during high volume manufacture. The right electrode contains a polymeric binder of unsuitable properties providing a viscosity outside the desired range and resulting in a poor print uniformity during high volume manufacture.

1. A method of printing an electrolyte for an electrochemical cell, the method comprising:
providing an ink, the ink comprising a solvent and an electrolyte-forming material, the electrolyte-forming material comprising an electrolyte species and a polymer;
printing the ink onto a medium to form an ink layer on the medium; and
allowing the ink to dry or cure to cause the electrolyte forming material to form an electrolyte layer on the medium.

2. The method of claim 1, wherein the step of printing the ink uses a high-speed printing process having a print rate of at least 10 metres per minute.

3. The method of claim 1, wherein step of printing the ink uses flexographic printing, rotary screen printing, rotogravure printing or reel-to-reel printing.

4. The method of claim 1, wherein the ink layer has a thickness that is 100 microns or less.

5. The method of claim 1, wherein the ink has a viscosity in the range of approximately 50 to approximately 500 centipoise when measured at a shear rate of 1000 to 100,000 s⁻¹.

6. The method of claim 1, wherein the polymer is capable of forming a connected polymer network on drying or curing.

7. The method of claim 6, wherein the polymer is a carbon-backboned polymer with polar side groups.

8. The method of claim 7, wherein the polymer is a cross-linkable polymer, and the method comprises allowing the ink to cure by allowing the polymer to form cross-links.

9. The method of claim 8 wherein the polymer comprises polyvinyl alcohol, polyacrylamide, polyacrylic acid, polycarbonate, polysulfone or polyurethane.

10. The method of claim 8, wherein the electrolyte-forming material further comprises a cross-linking catalyst configured to catalyse the formation of cross-links in the polymer.

11. The method of claim 10, wherein the cross-linking catalyst comprises an oxidising species.

12. The method of claim 10, wherein the ink comprises approximately 0.001 wt % to approximately 1 wt % cross-linking catalyst.

13. The method of claim 1, wherein the ink comprises approximately 1 wt % to approximately 50 wt % polymer.

14. The method of claim 1, wherein the ink comprises approximately 1 wt % to approximately 50 wt % electrolyte species.

15. The method of claim 1, wherein the electrolyte-forming material further comprises a surfactant.

16. The method of claim 15 wherein the surfactant comprises a long chain anionic molecule, a long chain cationic molecule, a non-ionic molecule and/or an amphoteric molecule.

17. The method of claim 1, wherein the electrolyte-forming material further comprises an additive.

18. (canceled)

19. (canceled)

20. (canceled)

21. (canceled)

22. (canceled)

23. The method of claim 1, further comprising:
printing a further ink layer over the ink layer, the further ink layer comprising a solvent and a further electrolyte-forming material, the further electrolyte-forming material comprising an electrolyte species and a second polymer different to the first polymer, and
allowing the first and second ink layers to dry or cure to form the electrolyte layer on the medium.

24. The method of claim 23, comprising allowing the first and second ink layers to dry or cure simultaneously to form the electrolyte layer on the medium.

25. The method of claim 24, wherein the first and second polymers are selected to react together, and wherein the method further comprises:
allowing the first ink and the second ink to react at an interface between the first ink layer and the second ink layer as the first and second ink layers dry or cure to form the electrolyte layer on the medium.

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)
